(19) United States
(12) Patent Application Publication
(10) Pub. No.: US 2008/0104857 A1
(43) Pub. Date: May 8, 2008

(54) Multistage Continuous Microwave Dryer For Plate-Shaped Products, Especially Fiber Boards

(75) Inventors: Anton Hecht, Lindau (DE); Anton Hendl, Weissensberg (DE)

Correspondence Address: FASSE PATENT ATTORNEYS, P.A., P.O. BOX 726, HAMPDEN, ME, 04444-0726, US

(73) Assignee: LINDAUER DORNIER GESELLSCHAFT MBH, LINDAU, GERMANY (DE)

(21) Appl. No.: 11/791,555

(22) PCT Filed: Nov. 21, 2005
(86) PCT No.: PCT/DE05/02092

§ 371 Date: May 23, 2007

(30) Foreign Application Priority Data
Nov. 24, 2004 (JP) 10-2004-056-795.6

(51) Int. Cl. F26B 3/34

(52) U.S. Cl. 34/259

(57) ABSTRACT

The aim of the invention is to create a multistage continuous microwave dryer for plate-shaped products, especially fiber boards, using microwave energy as a drying means while taking preventive steps that allow for an optimal drying process of the fiber boards. Said aim is achieved by disposing the rod antennas (12) above each plane of conveyance of the continuous microwave dryer (1), embodying the belt conveyor (6, 7, 8) on the respective plane of conveyance as a metallic perforated belt that can be effective as a reflective shield for the rod antennas, placing means (13a, 13b) for sucking off humid air between the rod antennas (12), said means acting as a reflective shield, and connecting the means for sucking off humid air to a common negative pressure source.

The invention relates to a multistage continuous microwave dryer for plate-shaped products, especially fiberboards, according to the features of the preamble of patent claim 1.

DE 37 35 242 C2 discloses a dryer plant for building boards, especially for gypsum fiberboards or gypsum chip boards, designated hereafter as boards, in which the boards are laid onto a conveyor belt for drying and the water fraction contained in the boards is extracted by the supply or generation of heat. The drying operation is in this case carried out in two stages, in that predrying takes place in a convection dryer and postdrying takes place in a dryer operated with high-frequency energy.

The convection dryer is designed as a multistage dryer. Hot-air nozzles arranged at the top and bottom ensure the predrying of the boards.

The device serving for the postdrying of the boards consists of a high-frequency dryer with a first and a second high-frequency zone, the two high-frequency zones being connected to one another by means of a connection member. The board transport means used in the high-frequency dryer is preferably a glass fiber conveyor belt which exerts no adverse influence during the transmission of the high-frequency energy to the boards.

A residual moisture in the boards which is detected after the run through the dryer plant is to be kept constant by a change in the run-through speed or by regulating the power of the high-frequency field.

The abovementioned document gives no information on the construction of the high-frequency dryer and on means for absorbing the moist air in the high-frequency dryer which occurs during the drying process.

Furthermore, a device for the heating, especially preheating, of pressed material by means of microwave energy is known from DE 101 57 601 A1. The microwave preheating device consists of a heating cell which is designed as a continuous furnace and in which the microwaves are fed into the pressed material via rod antennae arranged one behind the other and having reflection screens which, lying horizontally and transversely to the production directions are mounted above and/or below the pressed material within the heating cell.

The rod antennae are assigned in each case reflection surfaces on the opposite surfaces of the pressed material. The pressed material is led on a conveyor belt through the continuous furnace, the conveyor belt consisting of plastic.

The device disclosed here is aimed at the heating or preheating of pressed material. There is no mention here of a device for extracting the moisture contained in fiberboards.

Furthermore, dryers operating in the microwave range are known from the literature “Trocknungstechnik [Drying Technology]”, volume 2, K. Kröll, Trockner und Trocknungsverfahren [Dryers and drying methods], 2nd edition, Springer-Verlag, pages 416 to 418.

The high-frequency energy is led to the fiberboards, as the material to be dried, through waveguides from a high-frequency generator, also designated as a magnetron.

If, in the fiberboards moved through the dryer, the energy is to be absorbed over a relatively large surface for uniform drying, the waveguides are of meander-shaped design. In this case, the waveguide may be provided with a water inflow and outflow.

Furthermore, microwave conveyor belt dryers, as they may be referred to, are known from the above-mentioned literature. A resonator space and drying space arranged above the conveyor belt carries, on top, a plurality of magnetrons, the microwave energy of which radiates into this space. An air supply and discharge is arranged on the resonator space and drying space.

This literature reference gives no information on the arrangement of rod antennae in a multistage board dryer, on a compensation of the thermally induced elongation of the rod antennae and on the type of conveyor belt.

Proceeding from the abovementioned prior art, the object on which the invention is based is to provide a multistage continuous microwave dryer for plate-shaped products, especially fiberboards, using microwave energy as drying means and to provide measures which make it possible to have an optimal drying process for the fiberboards. The object is achieved, according to the invention,

in that the rod antennae are arranged above each transport level of the continuous microwave dryer, in that the conveyor belt on the respective transport level is a metallic traveling screen which may be active as a reflection screen for the rod antennae, in that means for the suction extraction of moist air, which are active as a reflection screen, are arranged between the rod antennae, and
in that the means for the suction extraction of moist air are connected to a common vacuum source.

With the rod antennae being produced from hollow material, their cavity may be a duct through which coolant flows.

If no cooling is provided, the rod antennae may be elongated during their active time. This elongation leads to a change in the distance of the antenna from the material to be dried and therefore to a change in the set focusing of the microwave energy maxima.

According to the invention, therefore, in a further refinement, there is provision for arranging at least one end of each rod antenna tension means for compensating the thermally induced elongation which are active permanently in the direction of its longitudinal axis.

The tension means may in this case be, for example, of a mechanical type, such as, for example, a tension spring.

A pneumatically acting tension device may also be envisaged.

In a further refinement of the invention, the continuous microwave dryer according to the invention may also be used in combination with a convection dryer, in that the continuous microwave dryer is used for the predrying or the postdrying of the fiberboards. For raising the core and reaction temperature in the fiberboards, furthermore, the continuous microwave dryer may be arranged between a first and a second convection dryer.

The advantages achievable by virtue of the invention are essentially that, using metallic traveling screens as transport means for the boards to be dried, high process temperatures exert no influence on the useful life of the transport means.

In multistage continuous microwave dryers, the metallic traveling screens may advantageously be active as a reflection screen for the rod antennae emitting microwaves.

Only the use of rod antennae makes it possible for a continuous microwave dryer to have a multistage design. Furthermore, the use of rod antennae has the advantageous result that a continuously uniform energy potential can be achieved in each stage of the dryer, this having a positive influence on the drying process and on the quality of the final product.

Furthermore, the formation of a defined space above each rod antenna entails an optimal reflection of the microwaves onto the fiberboards and consequently an optimal energy output.

The invention will be explained in more detail below with reference to an exemplary embodiment.

In the drawings:

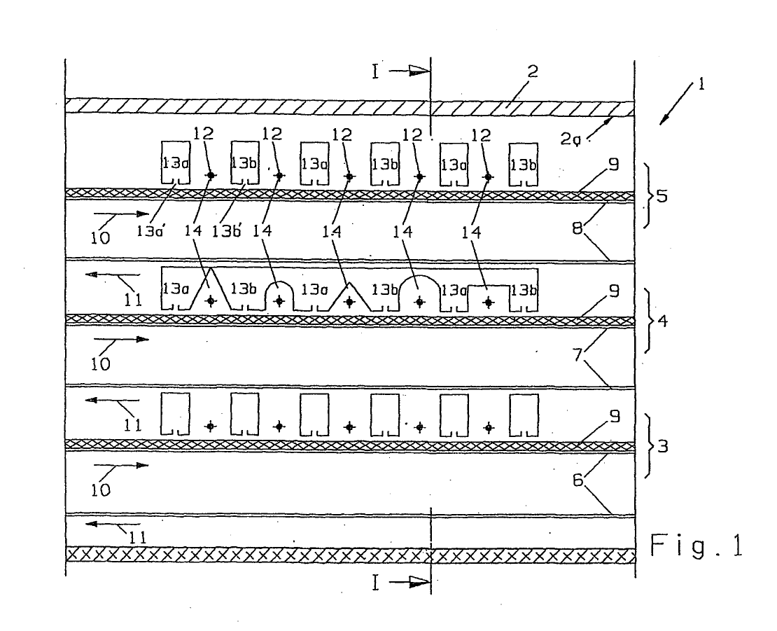

FIG. 1 shows a diagrammatic sectional illustration of the multistage continuous microwave dryer,

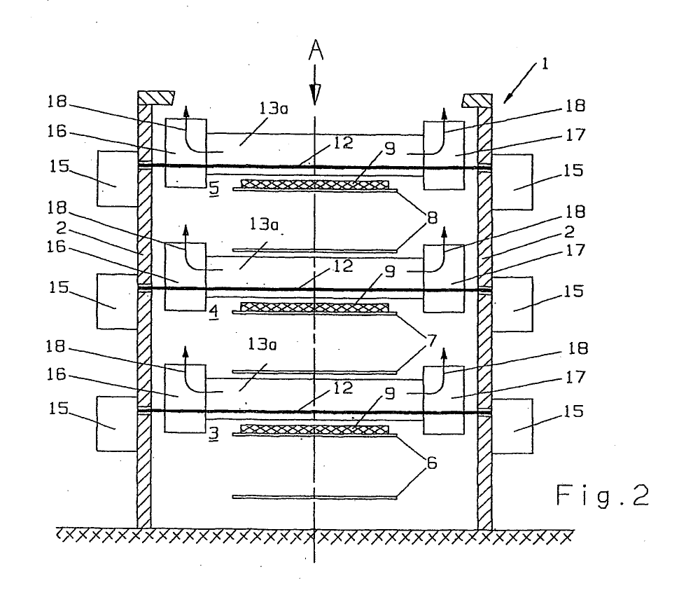

FIG. 2 shows a diagrammatic sectional illustration of the multistage continuous microwave dryer along the line I-I in FIG. 1,

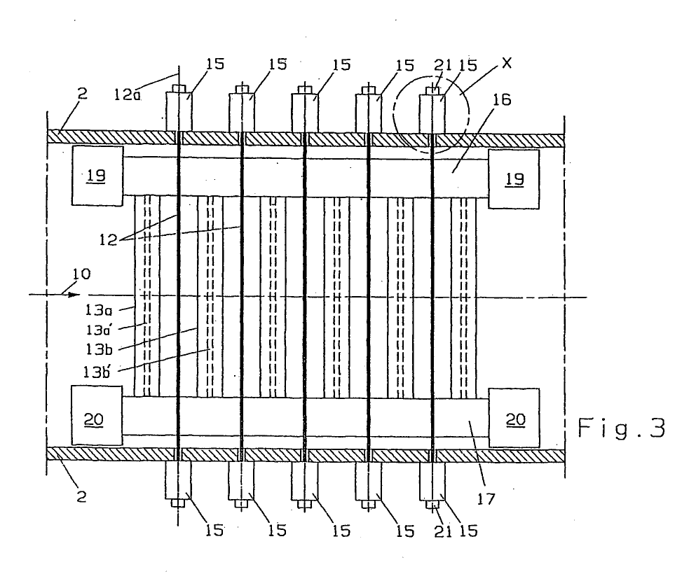

FIG. 3 shows a diagrammatic sectional illustration of the continuous microwave dryer according to the view “A” in FIG. 2,

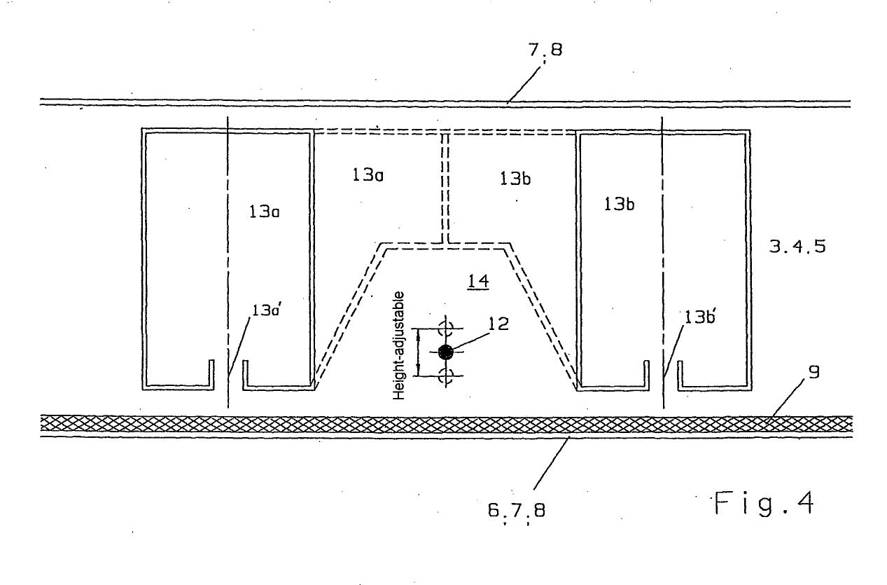

FIG. 4 shows a diagrammatic sectional illustration of the means for the suction extraction of moist air with a vertically adjustable rod antenna arranged between them, and

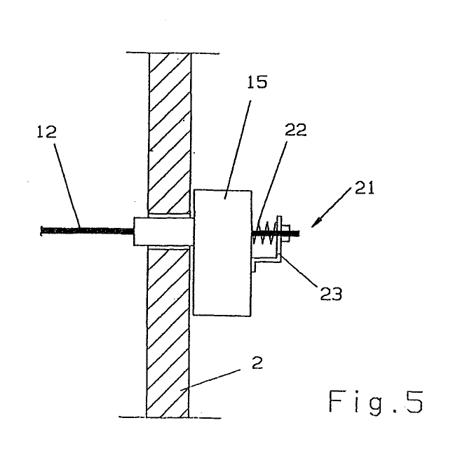

FIG. 5 shows a diagrammatic sectional illustration of the mechanically acting tension device for the rod antenna.

The continuous microwave dryer 1 illustrated in FIG. 1 is of multistage design. A conveyor belt 6, 7, 8, on which the material to be dried 9, fiberboards in the present case, lies, is guided horizontally in each case in a stage 3, 4, 5 in a housing 2.

The conveyor belts 6, 7, 8 are what are known as metallic endless traveling screens, of which each traveling screen is moved continuously in the direction of the arrows 10 and 11 by means of a drive of controllable rotational speed which is not illustrated here.

The microwave energy to be supplied to the material to be dried is emitted via what are known as rod antennae 12 which are arranged, spaced vertically apart from the respective traveling screen 6, 7, 8 carrying the material to be dried 10, in each stage 3, 4, 5 above the material to be dried. The arrangement is in this case provided such that each rod antenna 12 is surrounded by the means reflecting the microwave energy.

A first reflecting means in the stage 5 is the inside 2a of the housing top 2 and in the remaining stages 3 and 4 is the metallic traveling screen running back according to the direction arrow 11.

A second reflecting means is the outer side wall of the means 13a, 13b for the suction extraction of moist air, of which the side wall of the first means 13a is arranged on one side, spaced apart from the longitudinal center axis 12a, see also FIG. 3, of the rod antenna 12, and the side wall of the second means 13b is arranged on the other side of said longitudinal center axis 12a. In terms of the reflection action of the side walls, it is advantageous if the means 13a and 13b are designed with a cross section deviating from a rectangular shape, as illustrated in stage 4 of the continuous microwave dryer 1.

It is conceivable that only the reflecting side wall of the means 13a and 13b runs at an acute angle to the vertical such that the inside 2a of the housing 2 and the traveling screen running back are inactive as a reflection screen. The microwaves reflecting from the respective surfaces of the means 13a, 13b can therefore arrive along a short path at the transport material and actively assist the drying process.

Further geometric shapes of a reflection screen are illustrated in stage 4 according to FIG. 1.

FIG. 2 illustrates the arrangement of the rod antennae 12 over the treatment width of the continuous microwave dryer 1.

The free ends of the rod antennae 12 arranged, in the respective stage 3, 4, 5, above the respective conveyor belt 6, 7, 8 running forward are guided through the lateral housings 2 of the continuous microwave dryer and are operatively connected in each case to a high-frequency generator 15 (magnetron) which is arranged on the housing 2.

At least one first and second suction-air duct 19, 20 which runs vertically in the continuous microwave-dryer 1 over all the stages 3, 4, 5 and into which suction-air ducts 16, 17 running horizontally issue is arranged at least one common vacuum source which is not illustrated here. Each suction-air duct 16, 17 is connected, in turn, to the lateral ports of the means 13a, 13b for the suction extraction of moist air. The suction action of the suction-air ducts 16, 17 is illustrated by the direction arrows 18.

FIG. 3 shows the number of rod antennae 12 arranged in each stage 3, 4, 5 in the running direction of the material to be dried, along with the associated magnetrons 15.

Furthermore, FIG. 3 illustrates the suction-air routing, commencing at the means 13a, 13b for the suction extraction of moist air, with the suction ports 13a′, 13b′ which issue into horizontally guided suction-air ducts 16, 17 which, in turn, are connected to vertical suction-air ducts 19, 20.

FIG. 4 shows an enlarged illustration of the arrangement of the rod antenna 12 with the indicated vertical adjustability between a first and a second means 13a, 13b for the suction extraction of moist air in any stage 3, 4, 5 of the continuous microwave dryer 1. Each means 13a, 13b possesses, opposite the conveyor belt 6, 7, 8 or the material to be dried 9 lying on the conveyor belt, at least one slit-shaped suction-air port 13a′, 13b′. Above the means 13a, 13b is located the metallic conveyor belt 7, 8 running back, which is active as a reflection screen in the same way as those side surfaces of the means 13a, 13b which face the rod antenna 12.

The broken lines of the means 13a, 13b indicate another geometric configuration of these means, specifically such that the reflecting surfaces are spaced apart only slightly and surround the rod antenna 12 with the effect of a reflection screen. Other geometric configurations are illustrated by way of example in FIG. 1.

FIG. 5 shows the detail X from FIG. 3. A free end of the respective rod antenna 12 is led through the respective magnetron 15 in such a way that a thermally induced elongation can be compensated. The magnetron 15 is connected by suitable means and at a suitable point to the housing 2 of the continuous microwave dryer 1. The compensation of the thermally induced elongation of the rod antenna 12 takes place, then, in that a mechanical tension device 21, consisting of a spring 22 supported on the magnetron, is active permanently on a spring-elastic yoke 23 which is arranged firmly on the housing and to which the rod antenna 12 is suitably connected.

1. A multistage continuous microwave dryer for plate-shaped products, especially fiberboards, first fiberboards which contain a moisture fraction being guided on a first transport level of a first stage (3) by means of a first conveyor belt (6), and second fiberboards which contain a moisture fraction being guided on at least one transport level of at least one second stage (4) and at the same time being exposed to microwave energy, the microwave energy being fed into the fiberboards (9) via rod antennae (12) arranged axially parallel in the horizontal plane and transversely to the transport direction of the fiberboards (9) and consisting of solid or hollow material, and, for focusing the energy maxima, the rod antennae being adjustable in relation to the transport levels of the continuous microwave dryer by means of a height adjustment device, characterized in that the rod antennae are arranged above each transport level of the continuous microwave dryer (1), in that the conveyor belt (6, 7, 8) on the respective transport level is a metallic traveling screen which may be active as a reflection screen for the rod antennae, in that metallic means (13a, 13b) for the suction extraction of moist air, which are active as a reflection screen, are arranged between the rod antennae (12), and in that the means (13a, 13b) for the suction extraction of moist air are connected to at least one common vacuum source.

2. The continuous microwave dryer as claimed in claim 1, characterized in that, with the rod antennae (12) being produced from hollow material, their cavity is a coolant duct.

3. The continuous microwave dryer as claimed in claim 1, characterized in that a tension device (21) for compensating a thermally induced elongation is provided at least at one end of each rod antenna (12).

4. The continuous microwave dryer as claimed in claim 1, characterized in that the means (13a, 13b) for the suction extraction of moist air are designed as a duct-like structure with at least one suction port (13a′, 13b′) directed onto the fiberboards (9) and are arranged over the width of the conveyor belt (6, 7, 8).

5. The continuous microwave dryer as claimed in claim 4, whereby each means (13a, 13b) possesses a cross-sectional shape such that a space (14) additionally closed upwardly is obtained above the respective rod antenna (12) within the continuous microwave dryer.

6. The continuous microwave dryer as claimed in claim 1, characterized by the combination with a convection dryer for the predrying of the fiberboards (9).

7. The continuous microwave dryer as claimed in claim 1, characterized by the combination with a convection dryer for the postdrying of the fiberboards (9).

8. The continuous microwave dryer as claimed in claim 1, characterized by the arrangement between a first and a second convection dryer for raising the core and reaction temperature in the fiberboards (9).

9. The continuous microwave dryer as claimed in claim 1, characterized by the arrangement downstream of a convection dryer, in the transport direction of the fiberboards (9), for equalizing the moisture content in the fiberboards (9).
